(19) United States
(12) Patent Application Publication
(10) Pub. No.: US 2019/0155549 A1
(43) Pub. Date: May 23, 2019

(54) FILE SYSTEM AND FILE STORAGE METHOD BASED ON LARGE-CAPACITY OPTICAL DISC LIBRARY

(71) Applicant: WUHAN OPSTOR TECHNOLOGY LIMITED COMPANY, Wuhan City, Hubei (CN)

(72) Inventors: Qiang CAO, Wuhan City (CN); Jie YAO, Wuhan City (CN); Xiaoqian LI, Wuhan City (CN)

(73) Assignee: WUHAN OPSTOR TECHNOLOGY LIMITED COMPANY, Wuhan City, Hubei (CN)

(21) Appl. No.: 16/314,085

(22) PCT Filed: Jul. 12, 2017
(86) PCT No.: PCT/CN2017/092655

§ 371 Date: Dec. 28, 2018

(30) Foreign Application Priority Data
Jul. 12, 2016 (CN) 201610545482.8

(51) Int. Cl. G06F 3/06; G06F 16/13; G06F 16/14; G06F 16/16

(52) U.S. Cl. CPC G06F 3/0677; G06F 3/0643; G06F 16/16; G06F 16/148; G06F 3/0605; G06F 16/13

(57) ABSTRACT

A file system and a file storage method operate in relation to a large-capacity optical disc library. The method includes receiving a file access request initiated by an application or a user and finding a file directory tree according to a file identifier and determining that a file corresponding to the file identifier is stored in a temporary storage or an optical disc library. If the file is stored in the temporary storage, the corresponding file in the temporary storage is opened according to a virtual address recorded in the file directory tree to complete corresponding access operation. If the file is not found in the file directory tree, the file is created in the temporary storage. The file system and the file storage method can implement the full automation of optical disc recording and reading and provide users with a general file access interface.

### TECHNICAL FIELD

The invention belongs to the technical field of optical disc storage, and in particular relates to a file system and a file storage method and system based on a large-capacity optical disc library.

### BACKGROUND ART

It has always been an important issue in the modern society to preserve digital information for a long-term. One feature of the data that needs long-term preservation is that once it is written and saved, it is rarely accessed, thus earning its name “cold data”. As traditional storage systems using tapes and discs as storage media can barely meet the requirement of long-term and stable storage, a storage system that is dedicated to archiving is needed to reduce storage costs and improve data stability. The optical disc storage medium, having the characteristics of the separation of its storage media and drive, is easy to store and may well meet the requirement of archiving storage. Meanwhile, the optical disc has obvious advantages in long-term storage and energy consumption. Currently, the most popular organization format of single disc data is the UDF file system. There are two types of data organization on a single disc, one defining a special format and the other adopting the UDF standard format. Masashiro UENO et al. proposed a CD-based disaster-prevention storage system, which uses SCSI commands to read and write optical discs and has limited applicability in that data reading and writing are restricted by the upper-level system. Colin Thompson from Sony introduced an optical disc storage system based on the UDF file system which is oriented to multimedia file data and virtualizes a single disc as a file volume via the characteristics of the UDF file system. However, the storage system still fails to provide a universal and uniform file access interface for multiple discs.

The above work takes the data organization format of a single disc into consideration without specifically considering how to effectively establish a uniform data storage format on multiple discs which allows external users to uniformly and consistently store and access the data on multiple physical discs through a standard POSIX interface. At present, the new large-capacity optical disc library can accommodate tens of thousands of large-capacity Blu-ray discs within a single cabinet. However, for a large-capacity optical disc library, it is unrealistic to manually manage tens of thousands of discs and data thereon.

### SUMMARY OF THE INVENTION

The object of the embodiments of the present invention is to provide a file system and a file storage method and system based on a large-capacity optical disc library. The current new optical disc library can accommodate tens of thousands of large-capacity Blu-ray discs within a single cabinet. However, with regard to a large-capacity optical disc library, it is unrealistic to manually manage tens of thousands of CDs and the data thereon. Therefore a new large-capacity optical disc library is desired to ensure that tens of thousands of large-capacity Blu-ray discs can be automatically managed within a single cabinet and all data files are stored and accessed in an uniform and consistent way through a standard POSIX interface so that full storage virtualization can be achieved.

The embodiments of the present invention are implemented via a file system and a file storage method based on a large-capacity optical disc library, the method including the following steps: receiving file access request initiated by an application or a user, the file access request carrying a file identifier;

finding a file directory tree according to the file identifier and determining that the file corresponding to the file identifier is stored in a temporary storage of the optical disc library or in a physical optical disc in the optical disc library;

if the file corresponding to the file identifier is stored in the temporary storage, the corresponding file in the temporary storage is opened according to the virtual address recorded in the file directory tree to complete the corresponding access operation;

if the file corresponding to the file identifier does not exist in the temporary storage but exists in the optical disc library instead, according to the physical address recorded in the file directory tree, the file content stored in the optical disc library is read into the temporary storage to complete the corresponding access operation via the temporary storage; and

if a file with a file identifier is desired to be created in the file directory tree, the file corresponding to the file identifier is created in the temporary storage and the virtual address thereof is added to the file directory tree.

Preferably, the file corresponding to the file identifier is created in the temporary storage and the virtual address thereof is registered in the file directory tree, further including:

determining whether the size of the file content newly added in the current temporary storage and not stored in the optical disc library reaches the storage space of one or more optical discs;

if the result of the determination is positive, the content of the newly added file is transferred to the one or more optical discs, and the file identifier and the physical address of the corresponding optical disc are added to the file directory tree in a mapping relationship.

Preferably, the file corresponding to the file identifier is created in the temporary storage and the virtual address thereof is registered in the file directory tree, further including:

determining whether the difference between the time when the file, stored in the current temporary storage and having a backup in the optical disc library, is last accessed and the current time exceeds a preset time threshold;

if the result of the determination is positive, the corresponding file is updated to the optical disc and the corresponding file content in the temporary storage is deleted and the file directory tree is updated.

Preferably, the file directory tree includes:

a file identifier of each file stored in the temporary storage and a virtual address thereof in the temporary storage; and/or,

a physical address of the file, wherein the physical address includes a physical number and an internal address of the optical disc to which the file belongs; and/or,

a mapping relationship between the virtual address and the physical address; and/or,

One or more of the file storage time, the version number after file access, the file size and the importance level of the file.

Preferably, the process of reading the file content stored in the optical disc library into the temporary storage, except that the corresponding access operation is completed by the temporary storage, further includes:

after the file read from the optical disc A completes the file update operation, the update portion is stored on another optical disc B, and the file identifier as well as the corresponding relationship between the internal offset address and the physical address of the file are updated in the file directory tree;

ratio D, the ratio of the updated file(s) on the optical disc A to the total number of files on the disc, is recorded and when the value of the ratio D exceeds the preset ratio threshold, the original files on the optical disc A are read and copied to the temporary storage, and the updated data on the optical disc B is read and merges with the original files in the temporary storage to generate a complete new file, and finally the complete updated file is written onto another optical disc C.

Preferably, the method further includes:

after the content of the optical disc A is copied, the related information of files stored on the optical disc A is archived and the optical disc A is sealed.

Preferably, the access operation includes: one or the combination of more than one of opening files, reading files, writing files, copying files, and cutting files.

On the other hand, the embodiment of the present invention further provides a file storage system based on a large-capacity optical disc library, the system including: a temporary storage, an optical drive set, an optical disc set, a mechanical disc-removing device and a server, specifically:

the temporary storage is configured to temporarily store the file data to be imported into the optical disc library and cache the file data got from the optical disc library;

the optical drive set is configured to implement physical recording and reading of the optical disc data;

the optical disc set is configured to store optical disc(s);

the mechanical disc-removing device implements physically loading the optical disc into and exiting the optical disc out of an optical drive via a mechanical arm; and

the server is configured to store a file directory tree, is configured to implement a file identifier stored on the temporary storage and the mapping between a virtual address of a file and a physical address of a file on the optical disc; and may receive the access operation by a user for the file, and invoke the temporary storage, the optical drive set, the optical disc set, and the mechanical disc-removing device to complete the corresponding access operation.

Preferably, the server is further configured to implement a standard POSIX file system access interface.

Preferably, the optical disc used in the system is specifically a write-once optical disc and/or an erasable optical disc.

The file system and the file storage method based on a large-capacity optical disc library provided by the embodiments of the present invention have beneficial effects as follows: the file system and the file storage method provided by the embodiments of the present invention can store archived data on a relatively inexpensive optical disc and virtualize a large number of optical discs into an entire storage pool (i.e., the optical disc library file volume) to overcome the defect of small single disc capacity. Therefore, files can be stored across the boundaries of discs and the recording and reading of discs are fully automated, and the users are provided with a general file access interface.

### BRIEF DESCRIPTION OF THE DRAWINGS

In order to illustrate the technical solutions in the embodiments of the present invention more clearly, the accompanying drawings intended to be used in the description of the embodiments or the prior art will be briefly described below. Obviously, the drawings in the following description are only embodiments of the present invention and other drawings may be got by those skilled in the art according to these drawings without inventive work.

FIG. 1 is a schematic flowchart of a file storage method based on a large-capacity optical disc library according to an embodiment of the present invention;

FIG. 2 is a schematic structural diagram of a file storage system based on a large-capacity optical disc library according to an embodiment of the present invention;

FIG. 3 is a schematic diagram of a logical structure of a file directory tree according to an embodiment of the present invention;

FIG. 4 is a schematic flowchart of a file writing method based on a large-capacity optical disc library according to an embodiment of the present invention;

FIG. 5 is a schematic flowchart of a file reading method based on a large-capacity optical disc library according to an embodiment of the present invention; and

FIG. 6 is a schematic diagram of a logical space division of a global file according to an embodiment of the present invention.

### DETAILED DESCRIPTION OF THE INVENTION

The present invention will be further described in detail below with reference to the accompanying drawings and embodiments in order to make the object, technical solutions and advantages of the present invention more clearly. It is understood that the specific embodiments described herein are merely illustrative of the invention and are not intended to limit the invention.

In order to explain the technical solutions described in the present invention, the following description will be made by way of specific embodiments.

### Embodiment 1

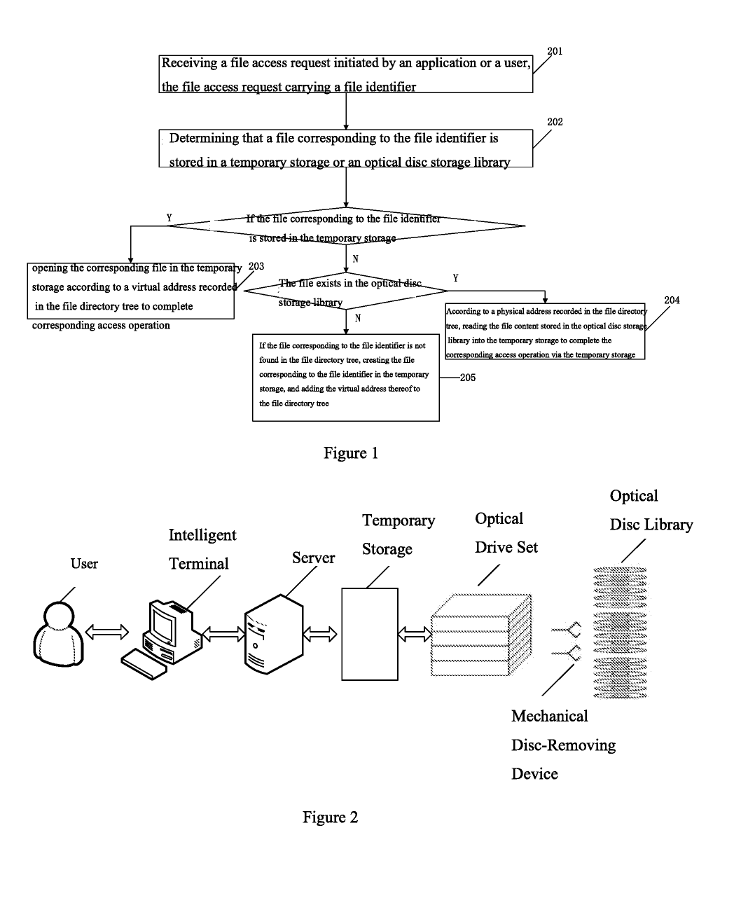

With reference to FIG. 1, a file system and a file storage method based on a large-capacity optical disc library according to an embodiment of the present invention. The method includes the following steps:

In step 201, file access request initiated by an application or a user is received, wherein the file access request carries a file identifier.

Wherein, the access operation includes one or a combination of more than one of opening a file, reading a file, writing a file, copying a file, and cutting a file.

In step 202, a file directory tree is found according to the file identifier, and it is determined that the file corresponding to the file identifier is stored in a temporary storage or an optical disc library.

Wherein, the file directory tree includes: a file identifier of each file stored in the temporary storage and a virtual address of the file in the temporary storage; and/or a physical address of the file, wherein the physical address includes a physical number and an internal address of the optical disc to which the file belongs; and/or a mapping relationship between the virtual address and the physical address; and/or one or more of the time the file is stored, the version number after file access, the size of the file and the importance level of the file.

In step 203, if the file corresponding to the file identifier is stored in the temporary storage, the corresponding file in the temporary storage is opened according to the virtual address recorded in the file directory tree to complete the corresponding access operation.

In step 204, if the file corresponding to the file identifier does not exist in the temporary storage but exists in the optical disc library instead, the file content stored on the optical disc is read into the temporary storage based on the physical address recorded in the file directory tree, and the corresponding access operation is completed via the temporary storage.

In step 205, if a file corresponding to the file identifier is intended to be created in the file directory tree, a file corresponding to the file identifier is created in the temporary storage and a virtual address thereof is added to the file directory tree.

The file system and the file storage method provided by the embodiment of the present invention can store the archived data on relatively inexpensive optical discs and virtualize a large number of optical discs into an entire storage pool (i.e., the optical disc library file volume) to overcome the defect of small single disc capacity. Therefore, files can be stored across the boundaries of discs and the recording and reading of discs are fully automated, and the users are provided with a general file access interface.

In the embodiment of the present invention, the storage space of the temporary storage generally reaches the storage capacity of dozens or even hundreds of optical discs, so the temporary storage allows storage in a period of time before it is copied to the optical disc. Preferably, after the user determines that the size of the content to be backed up and stored in the temporary storage reaches that of one or more disc(s), the disc recording operation may be triggered. In addition, there is a method of autonomous decision by the server. Specifically, there is an extensive solution in combination with the embodiment of the present invention, wherein the solution that the file corresponding to the file identifier is created in the temporary storage, and the virtual address thereof is registered in the file directory tree further includes:

determining whether the size of the file content newly added in the current temporary storage and not stored in the optical disc library reaches the storage space of one or more optical discs;

if the result of the determination is positive, the newly added file content is transferred to the one or more optical discs and the file identifier and the physical address of the corresponding optical disc(s) are added to the file directory tree in a mapping relationship.

In addition to the above mentioned method of completing the recording based on the newly added amount or the modified amount reaching the storage space of one or more optical discs, the embodiment of the present invention further provides a method for performing optical disc recording based on the determination of the modification time, specifically including:

there is a preferred solution in combination with the embodiment of the present invention, wherein the solution that the file corresponding to the file identifier is created in the temporary storage and the virtual address thereof is registered in the file directory tree further includes:

determining whether the difference between the time when a file, stored in the current temporary storage and having a backup in the optical disc library, is last accessed and the current time exceeds a preset time threshold;

if the result of the determination is positive, the corresponding file is updated into the optical disc library and the corresponding file content in the temporary storage is deleted and the file directory tree is updated.

The above mentioned two methods of respectively providing the file storage volume of the temporary storage and the file access time difference of the temporary storage to trigger optical disc recording, in the actual implementations, can be combined, that is, the optical disc recording is triggered only if the two requirements are concurrently satisfied. In this way, the efficiency of the use of optical discs is best optimized, that is, the data that truly has the meaning of backup is stored.

When the method of the embodiment of the present invention is specifically implemented, a situation may also be encountered in which the operator accesses the file data recorded into the optical disc and modifies the corresponding file and stores it in the temporary storage. At such time, if the disc on which the file data is provided is write-once, it is necessary to write the updated data into a new disc. However, as the ratio of the data read and modified in an optical disc is becoming bigger and bigger, and the amount of effective data is decreased, the efficiency of reading the optical disc is getting lower and lower each time. Therefore, a preferred solution in combination with the embodiment of the present invention is proposed, wherein after the file content stored in the optical disc is read into the temporary storage and the corresponding access operation is completed by the temporary storage, the solution further includes:

after the corresponding access operation on the file read from the optical disc A is completed, the updated data of the file is stored on another optical disc B;

recording the ratio D, the updated disc file(s) to the total number of files on the optical disc A, and updating the corresponding relationship between the file identifier and the physical address in the file directory tree; and

when the value of the ratio D exceeds the preset ratio threshold, the original files remaining on the optical disc A are read out and the corresponding updated data is read out from the optical disc B, and after the two are merged in the temporary storage the complete file after the update is copied to the optical disc B or another optical disc C.

Wherein, the ratio threshold may be set according to actual conditions. The embodiment of the present invention provides a preferred interval value according to the experimental result: 70%-85%.

There is a preferred solution in combination with the embodiment of the present invention, wherein the solution further includes:

after the content of the optical disc A is copied, the related information about the files stored on the optical disc A is archived and the optical disc A is sealed. The meaning of being sealed is to take the optical disc A out of the optical disc library and place it at a location where the optical discs are stored. The related information about the files specifically includes: the file directory tree on the optical disc A, the last modification time of each file, and the like.

### Embodiment 2

As shown in FIG. 2, the embodiment of the present invention further provides a file storage system based on a large-capacity optical disc library, the system comprising: a temporary storage, an optical drive set, an optical disc set, a mechanical disc-removing device, and a server, specifically:

the temporary storage is configured to temporarily store the file data to be imported into the optical disc library and cache the file data got from the optical disc library;

the optical drive set is configured to implement the physical recording and reading of the optical disc data;

the optical disc set is configured to store optical disc(s);

the mechanical disc-removing device implements physically loading the optical disc into and exiting the optical disc out of an optical drive via a mechanical arm; and

the server is configured to store a file directory tree, is configured to implement a file identifier stored on the temporary storage and the mapping between a virtual address of a file and a physical address of a file on the optical disc; and may receive the access operation by a user for the file, and invoke the temporary storage, the optical drive set, the optical disc set, and the mechanical disc-removing device to complete the corresponding access operation.

This embodiment can bring the following beneficial effects: 1) The system virtualizes a large number of optical discs into an entire capacity pool, in which files can be stored across the boundaries of optical disc(s) and the recording and reading of optical discs are fully automated and a user is provided with a general file access interface. 2) According to the characteristics of the optical disc library, to construct a new file system and file storage method facilitates the data management of the optical disc library and effectively improves the global file retrieval.

Combining with the embodiment of the present invention, there is a preferred implementation, in which the server is further configured to implement a standard POSIX file system access interface. Combining with the embodiment of the present invention, there is a preferred implementation wherein the optical disc used in the system is specifically a write-once optical disc and/or an erasable optical disc.

### Embodiment 3

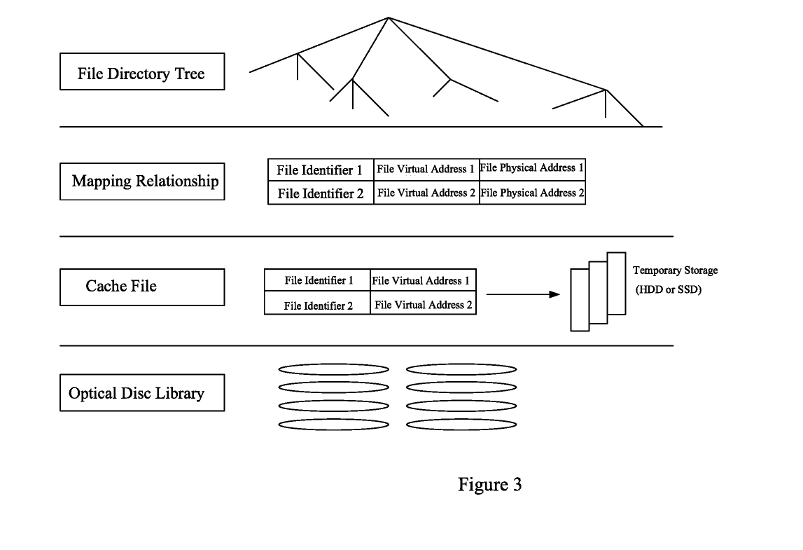

FIG. 3 shows the logical structure of a new file system for a large-capacity optical disc library, including a file directory tree, mapping relationships, cache files and an optical disc library.

The directory tree file records the global directory tree information, builds a global directory tree structure and improves the efficiency of file directory traversal. Wherein, any file and directory has a unique absolute path. In a specific implementation, the file storage system of the embodiment of the present invention uses the absolute path of the file and the directory as a key term to calculate the corresponding ID which is taken as a file identifier.

The cache file caches the file index information of the most recently imported and frequently accessed files. The index information includes the absolute path (physical address) of files in the optical disc library, the virtual address cached in the temporary storage, etc., and the internal system accesses the corresponding cache space via the absolute path of a file.

The mapping relationship records the index information of the files that need to be recorded to a disc, including the file ID, the physical storage location (such as the physical number of the optical disc and the internal address of the optical disc), and so on. And the internal system accesses the corresponding disc data through the file ID.

The above three index files will keep the latest copy in the data cache region and also be periodically recorded to a physical optical disc. However, considering that the metadata information will change with the use of the optical disc library, the three files have version information and the version number is automatically incremented each time when they are updated, so that it is guaranteed that the global metadata and the optical disc data are of the same version.

The working process of the system of the present invention is illustrated below:

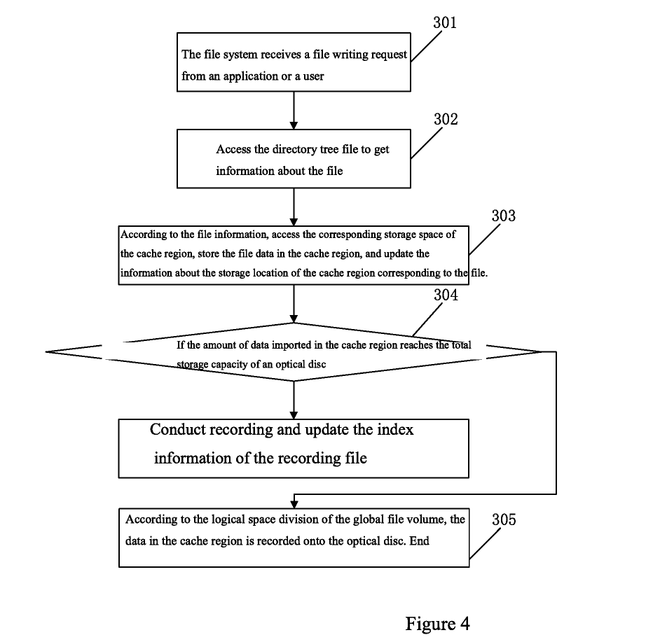

1. The data storage process is shown in FIG. 4, specifically including:

In step 301, the file system receives a file writing request from an application or a user.

In step 302, the file directory tree is accessed to get information about the file(s).

In step 303, the storage space of the corresponding cache region is accessed according to the file information, and the file data is stored in the cache region, and information about the storage location of the cache region corresponding to the file is updated.

In step 304, if the amount of data imported in the cache region reaches the total storage capacity of one disc, the process proceeds to step 305, otherwise it ends.

In step 305, the data in the cache region is recorded to the optical disc according to the logical space division of the global file volume, and the process ends.

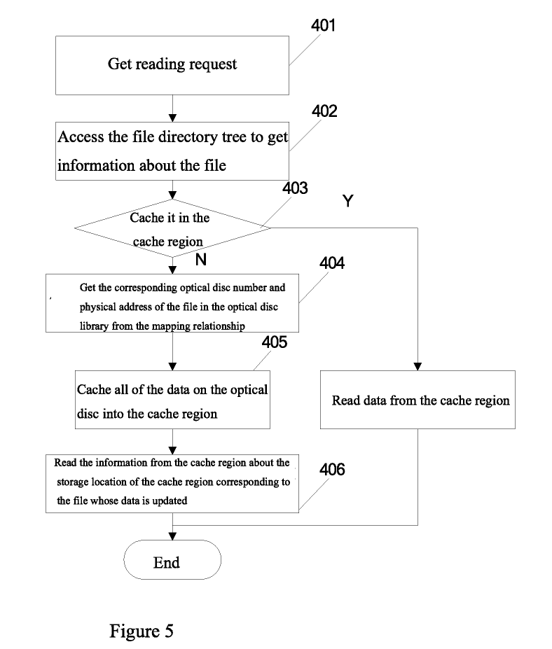

2. The data acquisition process is shown in FIG. 5, specifically including (wherein the temporary storage is also called the cache region):

In step 401, the file system receives a file reading request from an application or a user.

In step 402, the file directory tree is accessed to get information about the file(s).

In step 403, the storage space of the corresponding cache region is accessed according to the file information. And if the data of the file is cached in the storage space of the corresponding cache region, the file data is directly read from the cache region, and the process ends, otherwise, it proceeds to step 404;

In step 404, the disc number and physical address storing the file are got from the mapping file of the disc file.

In step 405, the data of the entire optical disc is cached into the cache region.

In step 406, the data is read from the cache region, and the information about the storage location of the cache region corresponding to the file is updated, and the process ends.

### Embodiment 4

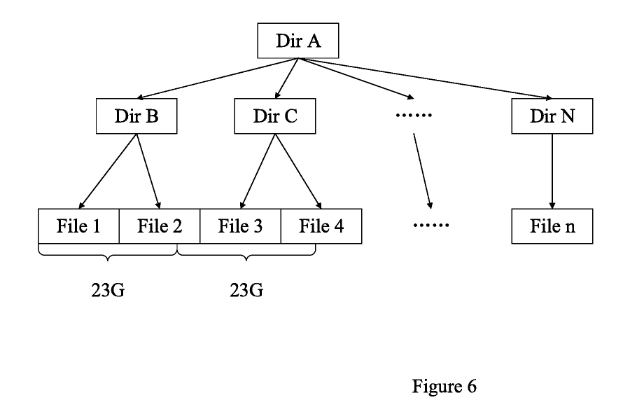

FIG. 6 shows a method for dividing the logical space of a global file volume according to an embodiment of the present invention, which can be applied to the foregoing embodiments.

The file system based on the large-capacity optical disc library saves the imported data in the data cache region, and then, according to the disc allocation algorithm, divides the data into a certain size of an optical disc image, and then records the image file to a physical optical disc at one time; Finally, after the recording is done, the index information of the file recorded to the optical disc is stored in the mapping relationship of the optical disc file, and the mapping relationship of the optical disc file is stored in the file relationship tree.

It will also be understood by those skilled in the art that all or part of the steps of the foregoing embodiments may be implemented by a program to instruct related hardware, and the program may be stored in a computer readable storage medium, which includes ROM/RAM, magnetic disc, optical disc, and the like.

The above is only the preferred embodiments of the present invention, and is not intended to limit the present invention. Any modifications, equivalent substitutions and improvements made within the spirit and principles of the present invention should be within the protection scope of the present invention.

1. A file storage method based on a large-capacity optical disc library, comprising:
receiving a file access request initiated by an application or a user, wherein the file access request carries a file identifier;
finding a file directory tree according to the file identifier, and determining that a file corresponding to the file identifier is stored in a temporary storage or an optical disc library;
if the file corresponding to the file identifier is stored in the temporary storage, opening the corresponding file in the temporary storage according to a virtual address recorded in the file directory tree to complete corresponding access operation;
if the file corresponding to the file identifier does not exist in the temporary storage but exists in the optical disc library instead, according to a physical address recorded in the file directory tree, reading file content stored in the optical disc library into the temporary storage and completing the corresponding access operation via the temporary storage; and
if the file corresponding to the file identifier is not found in the file directory tree, creating the file corresponding to the file identifier in the temporary storage, and adding the virtual address thereof to the file directory tree.

2. The file storage method according to claim 1, wherein creating the file corresponding to the file identifier in the temporary storage, and registering the virtual address thereof to the file directory tree further comprise:
determining whether the size of the file content newly added in the current temporary storage and not stored in the optical disc library reaches the storage space of one or more optical discs; and
if the result of the determination is positive, transferring the newly added file content to the one or more optical discs, and adding the file identifier and the physical address of the corresponding optical disc to the file directory tree in a mapping relationship.

3. The file storage method according to claim 1, wherein creating the file corresponding to the file identifier in the temporary storage, and registering the virtual address thereof to the file directory tree further comprise:
determining whether a difference between the time when a file, stored in the current temporary storage and having a backup in the optical disc library, is last accessed and the current time exceeds a preset time threshold; and
if the result of the determination is positive, updating the corresponding file to the optical disc library, deleting the corresponding file content in the temporary storage and updating the file directory tree.

4. The file storage method according to claim 1, wherein the file directory tree comprises:
the file identifier of each file stored in the temporary storage and the virtual address thereof in the temporary storage; and/or,
the physical address of the file, wherein the physical address includes a physical number and an internal address of the optical disc to which the file belongs; and/or,
a mapping relationship between the virtual address and the physical address; and/or,
one or more of the file storage time, the version number after file access, the file size, and the importance level of the file.

5. The file storage method according to claim 1, wherein reading file content stored in the optical disc library into the temporary storage and completing the corresponding access operation via the temporary storage further comprise:
after the corresponding access operation on the file read from an optical disc A is completed, storing the file on another optical disc B;
recording a ratio D, the ratio of the accessed file(s) on the optical disc A to the total number of files on the disc, and updating a corresponding relationship between the file identifier and the physical address in the file directory tree; and
when the value of the ratio D exceeds a preset ratio threshold, reading out and copying the original files remaining on the optical disc A onto the optical disc B or another optical disc C.

6. The file storage method according to claim 5, further comprising:
after the content of the optical disc A is copied, archiving the related information about files stored on the optical disc A and sealing the optical disc A.

7. The file storage method according to claim 1, wherein the access operation comprises:
one or the combination of more than one of opening files, reading files, writing files, copying files, and cutting files.

8. A file storage system based on a large-capacity optical disc library, the file storage system comprising:
a temporary storage;
an optical drive set;
an optical disc set;
a mechanical disc-removing device; and
a server, wherein:
the temporary storage is configured to temporarily store the file data to be imported into the optical disc library and cache the file data got from the optical disc library;
the optical drive set is configured to implement physical recording and reading of optical disc data;
the optical disc set is configured to store optical disc(s);
the mechanical disc-removing device implements physically loading the optical disc into and exiting the optical disc out of an optical drive via a mechanical arm; and
the server is configured to store a file directory tree, is configured to implement a file identifier stored on the temporary storage and the mapping between the virtual address of a file and a physical address of a file on the optical disc; and can receive an access operation by a user for a file, and invoke the temporary storage, the optical drive set, the optical disc set, and the mechanical disc-removing device to complete the corresponding access operation.

9. The file storage system according to claim 8, wherein the server is further configured to implement a standard POSIX file system access interface.

10. The file storage system according to claim 8, wherein the optical disc used in the system is specifically a write-once optical disc and/or an erasable optical disc.

11. The file storage method according to claim 2, wherein the file directory tree comprises:
the file identifier of each file stored in the temporary storage and the virtual address thereof in the temporary storage; and/or,
the physical address of the file, wherein the physical address includes a physical number and an internal address of the optical disc to which the file belongs; and/or,
a mapping relationship between the virtual address and the physical address; and/or,
one or more of the file storage time, the version number after file access, the file size, and the importance level of the file.

12. The file storage method according to claim 2, wherein reading file content stored in the optical disc library into the temporary storage and completing the corresponding access operation via the temporary storage further comprise:
after the corresponding access operation on the file read from an optical disc A is completed, storing the file on another optical disc B;
recording a ratio D, the ratio of the accessed file(s) on the optical disc A to the total number of files on the disc, and updating a corresponding relationship between the file identifier and the physical address in the file directory tree; and
when the value of the ratio D exceeds a preset ratio threshold, reading out and copying the original files remaining on the optical disc A onto the optical disc B or another optical disc C.

13. The file storage method according to claim 12, further comprising:
after the content of the optical disc A is copied, archiving the related information about files stored on the optical disc A and sealing the optical disc A.

14. The file storage method according to claim 3, wherein the file directory tree comprises:
the file identifier of each file stored in the temporary storage and the virtual address thereof in the temporary storage; and/or,
the physical address of the file, wherein the physical address includes a physical number and an internal address of the optical disc to which the file belongs; and/or,
a mapping relationship between the virtual address and the physical address; and/or,
one or more of the file storage time, the version number after file access, the file size, and the importance level of the file.

15. The file storage method according to claim 3, wherein reading file content stored in the optical disc library into the temporary storage and completing the corresponding access operation via the temporary storage further comprise:
after the corresponding access operation on the file read from an optical disc A is completed, storing the file on another optical disc B;
recording a ratio D, the ratio of the accessed file(s) on the optical disc A to the total number of files on the disc, and updating a corresponding relationship between the file identifier and the physical address in the file directory tree; and
when the value of the ratio D exceeds a preset ratio threshold, reading out and copying the original files remaining on the optical disc A onto the optical disc B or another optical disc C.

16. The file storage method according to claim 15, further comprising:
after the content of the optical disc A is copied, archiving the related information about files stored on the optical disc A and sealing the optical disc A.

17. The file storage method according to claim 2, wherein the access operation comprises:
one or the combination of more than one of opening files, reading files, writing files, copying files, and cutting files.

18. The file storage method according to claim 3, wherein the access operation comprises:
one or the combination of more than one of opening files, reading files, writing files, copying files, and cutting files.

19. The file storage method according to claim 4, wherein the access operation comprises:
one or the combination of more than one of opening files, reading files, writing files, copying files, and cutting files.

20. The file storage method according to claim 5, wherein the access operation comprises:
one or the combination of more than one of opening files, reading files, writing files, copying files, and cutting files.
